(19) United States
(12) Patent Application Publication
(10) Pub. No.: US 2015/0063226 A1
(43) Pub. Date: Mar. 5, 2015

(54) METHOD OF TRANSMITTING A DOWNLINK RADIO SIGNAL FROM A DISTRIBUTED ANTENNA SYSTEM TO A MOBILE DEVICE AND DISTRIBUTED ANTENNA SYSTEM

(71) Applicant: Amoesolu Corporation, Taipei City (TW)

(72) Inventors: Terng-Yin HSU, Taipei City (TW); Cheng-Yen CHEN, Taipei City (TW); Wen-Jye HUANG, Taipei City (TW); Ray-Shiang JEAN, Taipei City (TW); Shao-Ying YEH, Taipei City (TW); You-Hsien LIN, Taipei City (TW)

(73) Assignee: Amoesolu Corporation, Taipei City (TW)

(21) Appl. No.: 14/262,098

(22) Filed: Apr. 25, 2014

(30) Foreign Application Priority Data
Sep. 2, 2013 (TW) 102131524

(51) Int. Cl. H04W 72/04

(52) U.S. Cl. CPC H04W 72/042
USPC 370/329

(57) ABSTRACT

A method of transmitting a downlink radio signal from a distributed antenna system to a mobile device is provided. The distributed antenna system includes a plurality of transceivers and a control module. Each of the transceivers receives an uplink radio signal from the mobile device as a respective received signal. Each of the transceivers transmits the received signal to the control module. The control module provides to each of the transceivers the downlink radio signal with a respective intensity, which is determined by the control module according to an intensity of the received signal from the transceiver. Each of the transceivers transmits the downlink radio signal to the mobile device.

### CROSS-REFERENCE TO RELATED APPLICATION

This application claims priority to Taiwanese Application. No. 102131524, filed on Sep. 2, 2013.

### BACKGROUND OF THE INVENTION

1. Field of the Invention

The invention, relates to a method for communicating a signal, more particularly to a method of transmitting a downlink radio signal from a distributed antenna system to a mobile device.

2. Description of the Related Art

FIG. 1 illustrates a conventional method of transmitting a signal from a distributed antenna system 5 to a mobile device 7. The mobile device 7 is moved along a path 6. The distributed antenna system 5 includes a plurality of transceivers 51-54 arranged along the path 6, and a control module 50.

The control module 50 provides a downlink radio signal to each of the transceivers 51-54, which subsequently transmit the downlink radio signal to the mobile device 7.

However, the downlink radio signals transmitted respectively by the transceivers 51-54 are all received from the control module 50 and have the same frequency, and the transceivers 51-54 are generally not far apart from each other, resulting in co-channel interference among the downlink radio signals received by the mobile device 7 from respective transceivers 51-54. As a result, data throughput from the distributed antenna system 5 to the mobile device 7 may be adversely affected. For example, when, the mobile device 7 is moved to a position between the transceivers 51, 52, it may also receive the downlink radio signals from the transceivers 52-54, which may interfere with the downlink radio signal from the transceiver 51.

### SUMMARY OF THE INVENTION

Therefore, an object of the present invention is to provide a method of transmitting a downlink radio signal from a distributed antenna system to a mobile device, which is capable of providing relatively large data throughput for the mobile device.

According to the present invention, there is provided a method of transmitting a downlink radio signal from a distributed antenna system to a mobile device. The distributed antenna system includes a plurality of transceivers and a control module. The method comprises the following steps of: a) receiving, by each of the transceivers, an uplink radio signal from the mobile device as a respective received signal; b) transmitting, by each of the transceivers, the received signal to the control module; c) providing to each of the transceivers, by the control module, the downlink radio signal with a respective intensity, which is determined by the control module according to an intensity of the received signal from the transceiver; and d) transmitting, by each of the transceivers, the downlink radio signal.

According to another aspect of this invention, there is provided a distributed antenna system for transmitting a downlink radio signal to a mobile device. The distributed antenna system comprises a plurality of transceivers and a control module. Each of the transceivers is configured to receive an uplink radio signal from the mobile device as a respective received signal. The control module is configured to receive the received signal from each of the transceivers, and is operable to provide to each of the transceivers the downlink radio signal with a respective intensity, which is determined by the control module according to an intensity of the received signal from the transceiver.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional method of transmitting a signal from a distributed antenna system to a mobile device;

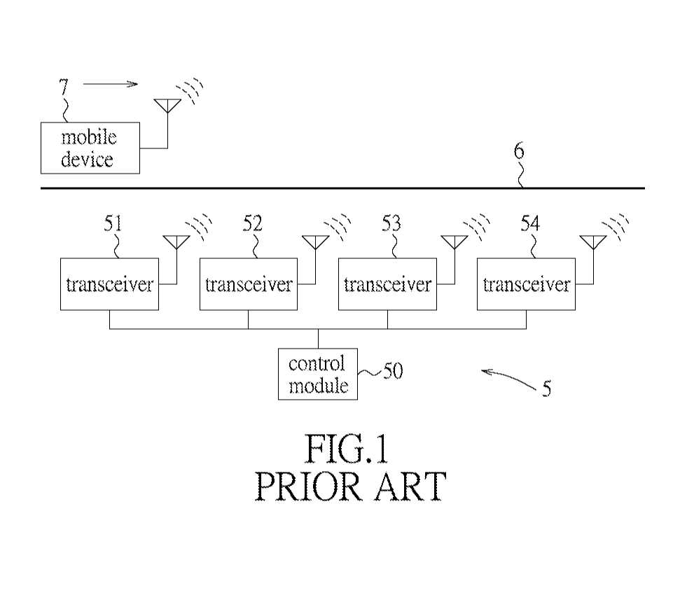

FIG. 2 is a flow chart illustrating a method of transmitting a radio signal from a distributed antenna system to a mobile device according to a first preferred embodiment of the present invention;

FIGS. 3 and 4 are schematic diagrams for illustrating the mobile device moving along a path and receiving the radio signal from the distributed antenna system according to the first preferred embodiment; and

FIGS. 5 and 6 are schematic diagrams for illustrating the mobile device moving along the path and receiving the radio signal from the distributed antenna system according to a second preferred embodiment of the method of this invention.

### DETAILED DESCRIPTION OF THE PREFERRED EMBODIMENTS

Before the present invention is described in greater detail, it should be noted that like elements are denoted by the same reference numerals throughout the disclosure.

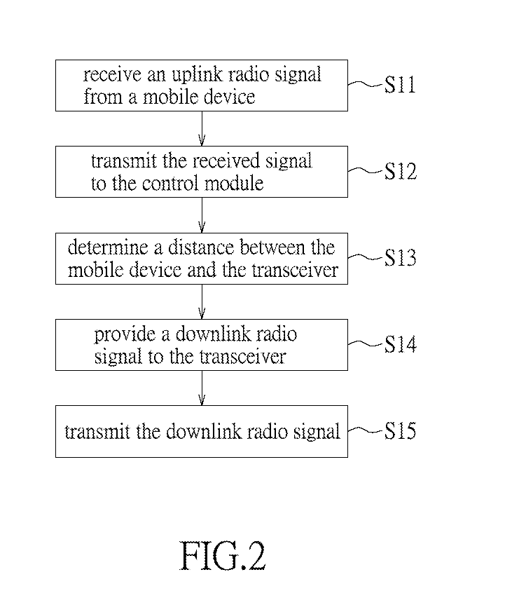

Referring to FIGS. 2 to 4, the first preferred embodiment of the method of transmitting a downlink radio signal to a mobile device 3 is implemented by a distributed antenna system 1. The distributed antenna system 1 includes a plurality of transceivers 11-14 and a control module 10. The transceivers 11-14 are arranged along a path 2.

In this embodiment, the path 2 may be a high speed railway, a train railway or the like, and the mobile device 3 may be a mobile communication device (such as a mobile phone or a tablet computer) disposed in a vehicle travelling along the path 2.

To reduce interference among radio signals transmitted from the transceivers 11-14, each of the transceivers 11-14 receives an uplink radio signal from the mobile device 3 as a respective received signal in step S11.

Each of the transceivers 11-14 is operable to transmit the received signal to the control module 10 in step S12, and the control module 15 is operable to determine a distance between the mobile device 3 and each of the transceivers 11-14 according to the intensity of the received signal from the transceiver 11-14 in step S13. In step S14, the control module 10 is operable to provide a downlink radio signal to each of the transceivers 11-14 with a respective intensity that negatively correlates with the distance between the respective one of the transceivers 11-14 and the mobile device 3. That is to say, the respective intensity of the downlink radio signal, provided to each of the transceivers 11-14 is determined by the control module 10 according to the intensity of the received signal from the transceiver 11-14. Then, in step S15, each of the transceivers 11-14 is operable to transmit the downlink radio signal to the mobile device 3.

Specifically, in step S13, the control module 10 is operable to determine which one of the transceivers 11-14 is proximate to the mobile device 3 among the remaining transceivers 11-14 according to the intensity (power) of the received signal from each of the transceivers 11-14. Then, in step S14, the control module 10 is operable to enhance the respective intensity of the downlink radio signal, which is provided to a proximate one of the transceivers 11-14, and/or to reduce the respective intensity of the downlink radio signal, which is provided to each of the remaining transceivers except for the proximate one, so as to increase data throughput to the proximate one of the transceivers 11-14.

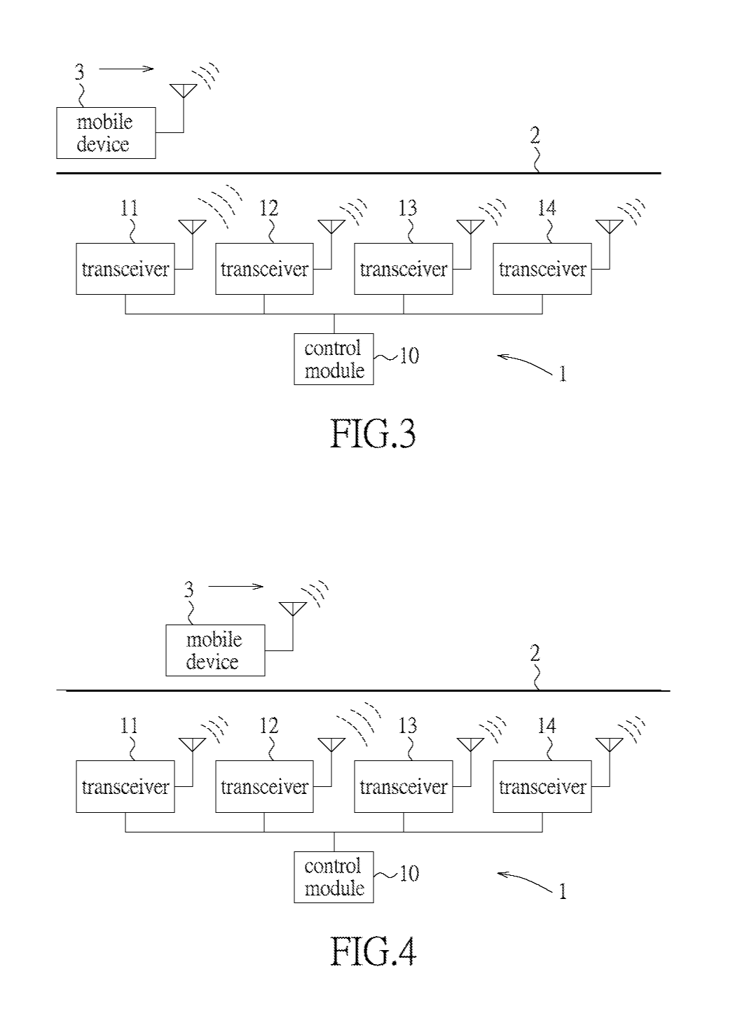

For example, as shown in FIG. 3, when the mobile device 3 is proximate to the transceiver 11, the control module 10 enhances the intensity of the downlink radio signal provided to the transceiver 11.

As shown in FIG. 4, when the mobile device 3 is moved to a position proximate to the transceiver 12 and away from the transceiver 11, e.g., a distance that the mobile device 3 is moved toward the transceiver 12 from the transceiver 11 is larger than half of a distance between the transceivers 11, 12, the control module 10 enhances the intensity of the downlink, radio signal provided to the transceiver 12 and reduces the intensity of the downlink radio signal provided to the transceiver 11 at the same time. Similarly, when a distance that the mobile device 3 is moved toward the transceiver 13 from the transceiver 12 is more than half of a distance between the transceivers 12, 13, the control module 15 enhances the intensity of the downlink radio signal provided to the transceiver 13 and reduces intensity of the downlink radio signal provided to the transceiver 12, and so forth.

Alternatively, the control module 10 may enhance the intensity of the downlink radio signal provided to at least one of the transceivers 11-14 that are at a distance from the mobile device 3 smaller than a predetermined value. Taking FIG. 4 as an example, when it is determined that the mobile device 3 is close to the transceivers 11 and 12, the control module 10 is operable to enhance the respective intensity of the downlink radio signal, which is provided to each of the transceivers 11, 12. It should he noted that, the control module 10 may reduce the intensity of the downlink, radio signal provided to at least one of the transceivers 11-14 that are at a distance from the mobile device 3 larger than a predetermined value in other embodiments of this invention.

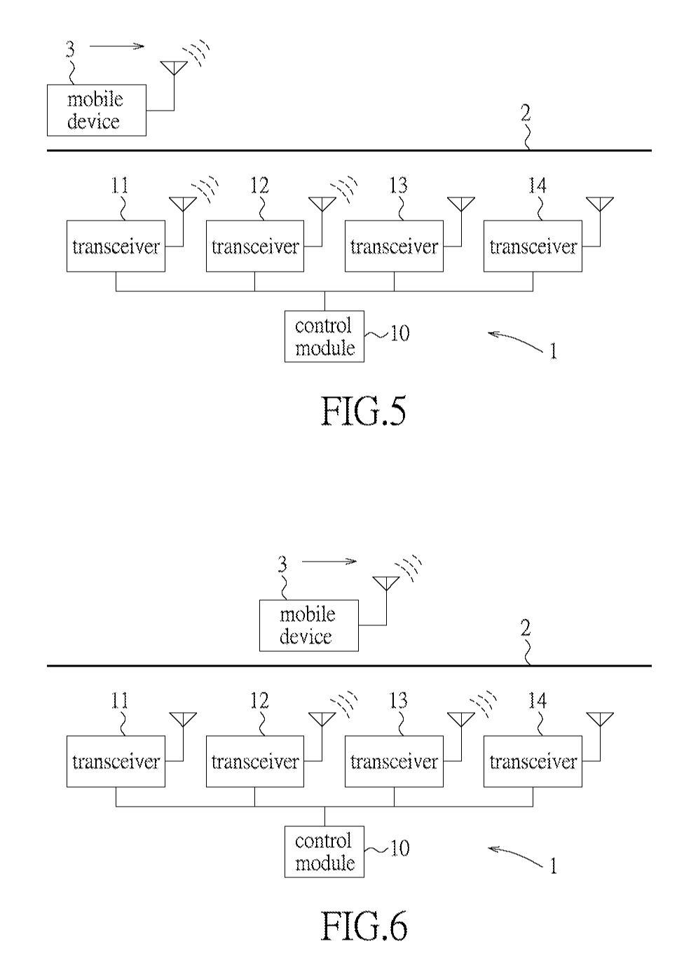

FIGS. 5 and 6 illustrate a method of transmitting a downlink, radio signal, from the distributed antenna system 1 to the mobile device 3 according to a second preferred embodiment of the present invention. In this embodiment, the distributed antenna system 1 is shown to be similar to the first preferred embodiment, and the control module 10 is operable, in step S13 (see FIG. 2), to determine a distance between the mobile device 3 and each of the transceivers 11-14 according to the intensity of the received signal from the transceivers 11-14. In step S14 (see FIG. 2), the control module 10 is operable to provide the downlink radio signal only to at least one of the transceivers 11-14 that is at a distance from the mobile device 3 smaller than a predetermined value. For example, the predetermined value is approximately equal to an average distance between any adjacent two of the transceivers 11-14.

For example, as shown in FIG. 5, when it is determined that a distance from the mobile device 3 to each of the transceivers 11, 12 is smaller than the predetermined value, the control module 10 provides the downlink radio signal only to the transceivers 11, 12. Further referring to FIG. 6, when the mobile device 3 is moved toward the transceiver 13 and away from the transceiver 11, the control module 10 provides the downlink radio signal only to each of the transceivers 12, 13 rather than to the transceivers 11, 14. Similarly, when the mobile device 3 is moved toward the transceiver 14 and away from the transceiver 12, the control module 10 provides the downlink radio signal only to each of the transceivers 13, 14 rather than to the transceivers 11, 12.

By this way, two of the transceivers 11-14 are always employed to transmit the downlink radio signals to the mobile device 3, thus ensuring communication stability between the mobile device 3 and the transceivers 11-14. Further, interference among the downlink radio signals received from transceivers 11-14 that are away from the mobile device 3 may be alleviated.

To sum up, in the present invention, each of the transceivers 11-14 first receives an uplink radio signal from the mobile device 3 as a respective received signal, and transmits the received signal to the control module 10. Next, the control module 10 determines a distance between the mobile device 3 and each of the transceivers 11-14 according to the intensity of the received signal from the respective one of the transceivers 11-14, and provides the downlink radio signal to each of the transceivers 11-14 with the respective intensity negatively correlating with the distance between the respective one of the transceivers 11-14 arid the mobile device 3. Finally, each of the transceivers 11-14 transmits the downlink radio signal to the mobile device 3. Therefore, the mobile device 3 may receive the downlink radio signal with relatively great intensity from the proximate one of the transceivers 11-14.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of transmitting a downlink radio signal from a distributed antenna system to a mobile device, the distributed antenna system including a plurality of transceivers and a control module, said method comprising the following steps of:
a) receiving, by each of the transceivers, an uplink radio signal from the mobile device as a respective received signal;
b) transmitting, by each of the transceivers, the received signal to the control module;
c) providing to each of the transceivers, by the control module, the downlink radio signal with a respective intensity, which is determined by the control module according to an intensity of the received signal from the transceiver; and
d) transmitting, by each of the transceivers, the downlink radio signal.

2. The method as claimed in claim 1, wherein, in step c), the control module is configured to:
determine a distance between the mobile device and each of the transceivers according to the intensity of the received signal from the transceiver; and
provide the downlink radio signal to each of the transceivers with the respective intensity negatively correlating with the distance between the transceiver and the mobile device.

3. The method as claimed in claim 1, wherein, in step c), the control module is configured to:
determine which one of the transceivers is proximate to the mobile device according to the intensity of the received signal from each of the transceivers; and
execute at least one of enhancing the respective intensity of the downlink radio signal, which is provided to a proximate one of the transceivers, and reducing the respective intensity of the downlink radio signal, which is provided to each of the remaining transceivers except for the proximate one.

4. The method as claimed in claim 1, wherein, in step b), the control, module is configured to:
determine a distance between the mobile device and each of the transceivers according to the intensity of the received signal from the transceiver; and
provide the downlink radio signal only to at least one of the transceivers that is at a distance from the mobile device smaller than a predetermined value.

5. A distributed antenna system for transmitting a downlink radio signal to a mobile device, said distributed antenna system comprising:
a plurality of transceivers, each of which is configured to receive an uplink radio signal from the mobile device as a respective received signal; and
a control module configured to receive the received signal from each of said transceivers, and operable to provide to each of said transceivers the downlink radio signal with a respective intensity, which is determined by said control module according to an intensity of the received signal from said transceiver.

6. The distributed antenna system as claimed in claim 5, wherein said control module determines a distance between said mobile device and each of said transceivers according to the intensity of the received signal, and provides the downlink radio signal to each of said transceivers with the respective intensity negatively correlating with the distance between the transceiver and the mobile device.

7. The distributed antenna system as claimed in claim 5, wherein said control module is operable to determine which one of said transceivers is proximate to said mobile device among the remaining transceivers according to the intensity of the received signal from each of said transceivers, and execute at least one of enhancing the respective intensity of the downlink radio signal, which is provided to a proximate one of said transceivers and reducing the respective intensify of the downlink radio signal, which is provided to each of the remaining transceivers except for the proximate one.

8. The distributed antenna system as claimed in claim 5, wherein said control module is operable to determine a distance between said mobile device and each of said transceivers according to the intensity of the received signal from said transceiver, and to provide the downlink radio signal only to at least one of said transceivers that is at a distance from the mobile device smaller than a predetermined value.
